(19) United States
(12) Patent Application Publication
(10) Pub. No.: US 2013/0218421 A1
(43) Pub. Date: Aug. 22, 2013

(54) SEMI-AUTOMATIC TIE TABLE CONTROL SYSTEM FOR A ROTATABLE AND TILTABLE TIE TABLE FOR A MID-SIZE OR BIG BALE STACK WAGON

(71) Applicants: LELAND K. MILLSAP, FRUITLAND, ID (US); SCOTT R. PIERCE, FRUITLAND, ID (US); RANDALL R. CLAGG, PAYETTE, ID (US)

(72) Inventors: LELAND K. MILLSAP, FRUITLAND, ID (US); SCOTT R. PIERCE, FRUITLAND, ID (US); RANDALL R. CLAGG, PAYETTE, ID (US)

(21) Appl. No.: 13/766,755

(22) Filed: Feb. 13, 2013

Related U.S. Application Data
(60) Provisional application No. 61/598,319, filed on Feb. 13, 2012.

(51) Int. Cl. A01D 85/00

(52) U.S. Cl. CPC A01D 85/005
USPC 701/50

(57) ABSTRACT

A tie table control system comprising a programmable logic controller and a tie table control sensor array of proximity sensors provides semi-automatic control of the movements of a rearward-hinged and forward-hinged, rotatable and tiltable tie table for a agricultural bale transport vehicle that selectively tilts and rotates a layer of bales resting thereupon generally 90 degrees relative to a preceding bale layer on the bale transport vehicle to criss-cross tie a stack load of bales (a plurality of layers of bales) together into a stack load to be offloaded to a field location or to a bale storage area.

### CROSS-REFERENCE TO RELATED APPLICATIONS

This application claims the benefit of U.S. Provisional Application No. 61/598,319, filed Feb. 13, 2012.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

### Field of the Invention

The present invention is a novel tie table control system 300 for controlling a rotatable and tiltable tie table 10 that replaces a preexisting non-rotatable and non-tiltable receiving table of a bale stack wagon 8 (such as a second table 210 of a New Holland™ bale wagon 208).

After a manual input into the control system by a vehicle operator, the tie table control system controls, monitors, and directs movement of the tie table throughout a complete tie cycle process that tilts and rotates a layer of bales generally 90 degrees relative to a preceding bale layer on a stack load table 14 of the bale stack wagon 8 to tie a stack load of bales together in an agricultural setting. Preferably, the bale transport vehicle is a mid-size or big bale stack wagon having a Mil-Stak® bale loader 12 previously installed or concurrently being installed.

The tie table control system also allows the operator to make manual inputs to the system to control distinct and selected movement (tilting and rotating) of the tie table.

The invention enables selective control of a hydraulic system 216 of the vehicle 8 in a lifting, tilting, rotating, and depositing of one mid-size or big bale or a plurality of mid-size or big bales from a bale tie table 10 of the bale stack wagon onto a rear-hinged stack load table 14 for consolation into a stack load with other layers of bales (commonly four or five layers) for transport from the field or for stacking in the field of the stack load for later transport by a stack load retriever vehicle. The invention allows selective control of a tie process by which the tie table performs a manipulation of a layer of bales (a generally 90 degree rotation of a layer of bales relative to a preceding layer of bales on the stack load table.

The invention serves as a useful control system for use with a rotatable and tiltable tie table modification to an existing bale stack wagon or bale transport vehicle such as a New Holland™ bale wagon vehicle series and other bale retrieval vehicles that incorporate a non-rotating, non-tilting bale receiving table proximate and forward of a rear-hinged stack load table.

The invention in its preferred embodiment provides a semi-automatic tie table control system that allows operator control of a tie table after conversion of a New Holland™ bale wagon or other bale retrieval or transport vehicle from a non-rotating, non-tilting receiving table bale retrieval or transport vehicle to a rotatable and tiltable tie table bale retrieval or transport vehicle.

### BRIEF SUMMARY OF THE INVENTION

A principal objective of this invention is to provide a novel tie table control system for controlling a rotatable and tiltable tie table for a mid-size or big bale stack wagon (such as a New Holland™ bale wagon) or other bale transport vehicle that is lightweight, compact, simple, low-maintenance, and reliable that allows a farmer, operator, or other user to control effectively a rotatable and tiltable tie table proximate and forward of a rear-hinged stack load table after modification from a non-rotating and non-tilting receiving table bale transport vehicle.

A further object of this invention involves a method of converting a bale wagon such as manufactured by New Holland North America, Inc. (New Holland) with a non-rotating, non-tilting receiving table that cannot rotate a bale layer to tie a plurality of stack load layers together into a bale transport vehicle capable of selectively rotating a bale layer generally 90 degrees relative to a preceding bale layer to tie a stack load of a plurality of mid-size or big bales into a more cohesive and stable group.

Additional and various other objects and advantages attained by the invention will become more apparent as the specification is read and the accompanying figures are reviewed.

In the preferred embodiment, a tie table control system is attached to a bale wagon that has been modified by removal and replacement of a non-rotating and non-tilting receiving table (such as a New Holland™ second table) with a rotatable and tiltable tie table to control the tie table. The tie table and the tie table control system are attached to the modified bale wagon by a plurality of conventional pins and clips, by bolts and nuts, and by easy connection of a plurality of hydraulic lines of a plurality of hydraulic tie table actuators of the tie table to the hydraulic system of the bale wagon and the tie table control system controls the rotatable and tiltable tie table and modifies a bale wagon control system.

The tie table control system in the preferred embodiment provides semi-automatic control of six hydraulic actuators of a rotatable and tiltable tie table that preferably include two tilting actuators 62, two rotation actuators 120, a table lifting actuator 58 of the preexisting non-rotating, non-tilting receiving table, and a booster strut actuator. In the preferred embodiment, the tie table and the semi-automatic tie table control system modify a preexisting New Holland™ hydraulic system 216 bale wagon control system to power and control the tie table actuators that actuate the tie table.

The semi-automatic tie table control system comprises a tie table programmable logic controller 302, a plurality of input and output signal lines attached between the logic controller and a preexisting bale wagon controller and a preexisting hydraulic system of the bale wagon, a plurality of input and output signal lines attached between the logic controller and the plurality of hydraulic valves that control movement of the plurality of actuators associated with movement of the tie table during use, a plurality of input and output signal lines attached between the logic controller and a tie table rotate and tilt valve block 354, a plurality of input and output signal lines attached between the logic controller and a tie table control sensor array 320 (the sensor array comprising a plurality of proximity sensors 322, 328, 334, 338, 346, 350 mounted to the tie table and the stack wagon or bale wagon or other bale transport vehicle, a plurality of sensor targets 324, 330, 340 mounted to the tie table and a sensor target that is a sensor target portion of a lower pivot frame 20 (preferably said sensor target portion is a generally vertical surface of a pivot plate 28 of the lower pivot frame), a plurality of input and output signal lines attached between the logic controller and a tie table operator control interface box 304, and a plurality of input and output signal lines attached between the logic controller and a bale wagon valve block. After the modification as taught herein, subsequent conversion to or from one configuration to the other can be rapidly and easily accomplished.

In the preferred embodiment, the tie table control system and the tie table are mounted to and from a preexisting New Holland™ bale wagon 208. When a New Holland™ bale wagon bale transport vehicle 208 already having a Mil-Stak™ bale loader 12 is modified, its preexisting non-rotating, non-tilting receiving table 210 is unmounted from the vehicle's main receiving table mounts before a tie table 10 is mounted to the same main receiving table mounts used with the removed table by use of the same main pivot bolts 44 and jam nuts 45. The replacing tie table can use the same table lifting actuator 58 previously used with the replaced table. Preferably, a booster strut assembly 180 having a table booster strut 182 powered by a hydraulic actuator on the same hydraulic circuit as the lifting actuator is attached to the bale stack wagon vehicle preferably using nuts and bolts and pins and retaining clips. The preferred embodiment uses hydraulic actuators, but other comparable devices including pneumatic actuators could be used.

The components of the semi-automatic tie table control system are attached to selected portions of the tie table 10 and to selected portions of the bale stack wagon vehicle 8.

The Mil-Stak™ rotatable and tiltable tie table replaces an OEM non-rotating and non-tiltable receiving table of a bale transport vehicle having a rear-hinged stack load table such as a second table of a New Holland™ bale wagon and allows a selective bale layer to be selectively rotated generally 90 degrees relative to a preceding bale layer to form a cross-tie layer in a load stack on a stack load table of the bale wagon.

The Mil-Stak™ tie table control system has utility and allows effective control of the rotatable and tiltable tie table and a tie cycle process performed using the tie table.

Operating the Mil-Stak™ tie table manually requires an operator to raise a tie table 10 up approximately 45 degrees from a home position (generally a horizontal position), lower the tie table proximate to the home position, tilt up portions of the tie table so an upper rotating table frame 130 of the tie table when subsequently rotated will physically clear a rear-hinged stack load table 14 of the bale wagon, rotate the upper rotating table frame generally 90 degrees from a home rotational position, tilt down portions of the tie table towards the home position, raise the tie table up approximately 90 degrees from the home position, tilt up the upper portions of the tie table to push a bale layer on the tie table backwards onto the stack load table, lower the tie table down to approximately 30 degrees above the home position, rotate the upper rotating table frame back to the home rotational position, then lower the tie table to the home position.

It is an object of the present invention to provide a semi-automatic tie table control system 300 for a tie table 10 on a bale stack wagon 8 that allows an operator to selectively initiate the control system to subsequently control the lifting, tilting, and rotation of a tie table throughout a tie cycle process.

It is another object of the tie table control system to provide a control system having a position sensing mechanism that will handle an interruption of an initiated tie cycle process without requiring the tie table to be moved to a known initial position.

It is yet another object of the tie table control system to provide a control system for a tie table that operationally couples discrete action initiation signals and corresponding actions into a unified, controlled operational tie cycle process requiring minimal operator input.

It is a still further object of the tie table control system to provide a sensing device for monitoring the position of the tie table as the control system controls the raising and lowering of the tie table to and from a slide bale position.

It is a still further object of the tie table control system to provide a sensing device for monitoring the position of the tie table as the rear portions of the tie table tilt up to a fully tilted up position.

It is a still further object of the tie table control system to provide a sensing device for monitoring the position of the tie table as an upper rotating table frame 130 rotates generally 90 degrees to a fully rotated clockwise position.

It is a still further object of the tie table control system to provide a sensing device for monitoring the position of the tie table as the control system tilts the rear portions of the tie table down to a home tilted down position.

It is a still further object of the tie table control system to provide a sensing device for monitoring the position of the tie table as the tie table raises to deliver a bale layer to the stack load table 14.

It is a still further object of the tie table control system to provide a sensing device for monitoring the position of the tie table as the control system tilts the rear portions of the tie table up to a fully tilted up position to push a bale layer rearward onto the stack load table.

It is a still further object of the tie table control system to provide a sensing device for monitoring the position of the tie table as the tie table lowers into a rotational position before an upper rotating table frame 130 rotates generally 90 degrees to a fully rotated counter-clockwise position.

It is a still further object of the tie table control system to provide a sensing device for monitoring the position of an upper rotating table frame as the upper rotating table frame rotates generally 90 degrees to the fully rotated counter-clockwise position.

It is a still further object of the tie table control system to provide a sensing device for monitoring the position of the tie table as the control system lowers the tie table down to the home position.

It is a still further object of the tie table control system to provide a control mechanism to reset the tie table control system to a neutral state after an initiated tie cycle process has completed.

It is a still further object of the tie table control system to provide a control mechanism to reset the tie table control system to a neutral state if the operator wishes to cancel an initiated tie cycle process.

It is a still further object of the tie table control system to provide a sensing and control system for a tie table that is durable in construction, inexpensive of manufacture, care free of maintenance, easily assembled, and simple and effective to use.

It is a still further object of the tie table control system to provide a sensing and control system to control and manipulate a replacing, rotatable and tiltable tie table that integrates with a preexisting control and sensing system of a bale stack wagon (such as a New Holland™ bale wagon) that was previously equipped with a non-rotatable and non-tiltable receiving table and to modify and/or take control of part or all of a bale wagon's existing hydraulic system regarding operation of the tie table.

It is a still further object of the tie table control system to provide a sensing and control system for a tie table that will ascertain the position of the tie table and determine if raising or lowering the stack load table might cause a collision between the two tables.

It is a still further object of the tie table control system to provide a sensing and control system for a tie table that will prevent (not allow) the stack load table from being raised or lowered if the sensing and control system determines that said raising or lowering of the stack load table might cause a collision between the two tables.

These and other objects are reached by providing a tie table control system having a tie table programmable logic controller for controlling and monitoring a tie cycle process and the lifting, tilting, and rotating of a tie table in which a plurality of sensors combined with a plurality of sensor targets enable the lifting (raising and lowering), tilting, and rotating of a tie table with minimal operator inputs.

### BRIEF DESCRIPTION OF THE SEVERAL VIEWS OF THE DRAWING

FIG. 1 is a perspective view of a rearward-hinged and forward-hinged, rotatable and tiltable tie table 10 in a generally horizontal, lowered, untilted, unrotated, home position and attached to a New Holland™ bale wagon 8 equipped with a Mil-Stak™ loader 12 and having a rear-hinged stack load table 14;

FIG. 2 is a perspective view of the tie table 10 shown in FIG. 1 in a rotated clockwise position generally 90 degrees rotated about a rotation axis perpendicular to both the longitudinal axis and the latitudinal axis of the tie table, the tie table in a partially raised, and the tie table in a fully tilted up position and attached to the bale stack wagon 8 and showing a booster strut 182 in a fully raised strut position;

FIG. 3 is a partial, perspective view of a prior art rearward-hinged, non-rotatable and non-tiltable receiving table 210 in a lowered home position and attached to a bale wagon 208 having a rear-hinged stack load table 14;

FIG. 4 is a partial, perspective view of the prior art rearward-hinged, non-rotatable and non-tiltable receiving table 210 shown in FIG. 3 in a fully raised position raised approximately 90 degrees upward by a table lifting actuator 58 attached to and between a centrally located actuator ear on the lower surface of the table and a table lifting actuator lower mounting ear 60 of the bale transport vehicle 208 and showing a prior art bale side stop 214;

FIG. 5 is a simplified schematic of a tie table control system 300;

FIG. 6 is a second simplified schematic of the tie table control system;

FIGS. 7a through 7e are various views of a tie tale operator control interface box 304;

FIG. 8 is a perspective view from slightly above the left front quarter of the tie table 10 shown in FIGS. 1 and 2 showing an upper inner table skin 154, two upper outer table skins 156, four adjustable table end bal stops 158, two adjustable table side bale stops 160, and three bale guide ridges 162;

FIG. 9 is a perspective view from slightly below the left front quarter of the tie table 10 shown in FIGS. 1, 2, and 8 in a fully tilted up position (a table lifting actuator 58, a table lifting actuator lower mounting ear 60, a table booster strut 182, are not shown);

FIG. 10 is a perspective view from the left front quarter from above of a lower pivot frame 20 shown in FIGS. 2, 8, and 9 showing two coaxial tilting pivot sleeves 40 respectively mounted in two distal ends of two spaced upper rails 36 of said lower pivot frame; a tie table tilt up sensor mounting bracket 64, a tie table tilt down sensor bracket 66, and a bale wagon table position sensor target linkage tab 67 on a pivot plate 28 (linkage tab joined to the pivot plate in a physical location equivalent to a similar tab on the replaced receiving table 210 that operatively participates in the movement of a bale wagon receiving table position sensor target that is observed by the bale wagon control system to generate three signals that correspond to a receiving table down signal, a receiving table at slide position signal, and a receiving table up signal;

FIG. 11 is a top plan view of an intermediate tilting table frame 70 showing two pairs of tilting pivot plates 74, a tie table rotate left sensor mounting bracket 122, a tie table rotate right sensor mounting bracket 124, a tilt up sensor target 324, a tie table rotate left sensor 328, and a tie table rotate right sensor 334;

FIG. 12 is a perspective view from the right front quarter from above of the intermediate tilting table frame 70 shown in FIG. 11;

FIG. 13 is a perspective view from the right front quarter from below of the intermediate tilting table frame 70 shown in FIG. 11;

FIG. 14 is a side plan view of the upper rotating table frame 130 shown in FIGS. 1, 2, 8, and 9;

FIG. 15 is a perspective, partially exploded view of the upper rotating table frame 130, the intermediate tilting table frame 70, and a segmented capture ring 118 of the upper rotating table frame (inner central table skin 154 and outer table skins 156 not shown);

FIG. 16 is a cross-sectional view showing the physical relationships between inner perimeters of four rings of a preferred embodiment of a four-ring fixed ring assembly 110 and outer perimeters of two rings of a rotating ring assembly 170, said four-ring fixed ring assembly is a portion of the intermediate tilting table frame 70 and said fixed ring assembly comprising a base ring 112 attached to and beneath, an ultrahigh molecular weight (UHMW) plastic ring 114 attached to and beneath, a segmented spacer ring 116 attached to and beneath, a segmented capture ring 118, said rotating ring assembly comprising an attachment ring 172 attached to an inner perimeter of a slider ring 174, and the outer perimeter of said slider ring slidingly captured and retained in the annular space between said plastic ring and said partially overlapping capture ring, and said rotating ring assembly is a portion of the upper rotating table frame 130;

FIG. 17 is a side plan view of the tie table 10 in a fully raised position and in a fully tilted down position and pivotally attached to a bale stack wagon 8 and showing the upper rotating table frame 130 oriented fore and aft and rotatably attached to the intermediate tilting table frame 70 and the intermediate tilting table frame pivotally attached to the lower pivot frame 20 and showing a booster strut mount 184 and a bale layer of phantom Bale 1 and Bale 2 after their deposit on the stack load table 14 by the tie table;

FIG. 18 is a side plan view of the tie table 10 in a lowered, unrotated, untilted, home position and attached to a bale stack wagon 8 and showing the upper rotating table frame 130 oriented fore and aft and rotatably attached to the intermediate tilting table frame 70 and the intermediate tilting table frame pivotally attached to the lower pivot frame 20 and showing an arc of elevation (raising) B of the entire tie table of approximately 90 degrees from the home position to a fully raised position;

FIG. 19 is a bottom plan view of the upper rotating table frame 130 rotatably joined to the intermediate tilting table frame 70 and the intermediate tilting table frame pivotally joined to the lower pivot frame 20 (table lifting actuator lower mounting ear, table lifting actuator, and booster strut assembly not shown);

FIG. 20 is a top plan view of the upper rotating table frame 130 rotatably attached to the intermediate tilting table frame 70 and the intermediate tilting table frame pivotally attached to the lower pivot frame 20 (main pivot bolts, table lifting actuator lower mounting ear, table lifting actuator, booster strut assembly, upper outer table skins and upper inner table skin not shown);

FIG. 21 is a side plan view of the tie table 10 attached to a bale stack wagon and raised to a slide bale position in a post first operation position after completion of a first operation of an operator initiated tie cycle process showing the upper rotating table frame 130 oriented fore and aft and rotatably joined to the intermediate tilting table frame 70 and the intermediate tilting table frame pivotally joined to the lower pivot frame 20 and showing a cutaway phantom bale layer of phantom Bale 3 and phantom Bale 4 upon the tie table (actuator 58, mounting ear 60, and booster strut assembly not shown);

FIG. 22 is a side plan view of the tie table 10 in a post second operation position after completion of a second operation of a tie cycle process showing the upper rotating table frame 130 oriented fore and aft and rotatably joined to the intermediate tilting table frame and the intermediate tilting table frame pivotally joined to the lower pivot frame 20 in a partially raised position and a home tilted down position and showing a cutaway phantom bale layer of phantom Bale 3 and phantom Bale 4 upon the tie table (actuator 58 and booster strut assembly not shown);

FIG. 23 is a side plan view of the tie table 10 in a partially raised position, a fully tilted up position, and in a post third operation position after completion of a third operation of a tie cycle process showing the upper rotating table frame 130 oriented fore and aft and rotatably joined to the intermediate tilting table frame 70 and the intermediate tilting table frame pivotally joined to the lower pivot frame 20 and showing the bale layer of phantom Bale 3 and Bale 4 after their deposit upon the tie table (lifting actuator 58 and booster strut assembly not shown);

FIG. 24 is a side plan view of the tie table 10 in a partially raised position, a fully tilted up position, and in a halfway rotated position during a fourth operation of a tie cycle process showing the upper rotating table frame 130 rotated approximately 45 degrees from fore and aft and rotatably joined to the intermediate tilting table frame and the intermediate tilting table frame 70 pivotally joined to the lower pivot frame 20 and showing the bale layer of phantom Bale 3 and Bale 4 upon the tie table (lifting actuator 58 and booster strut assembly not shown);

FIG. 25 is a bottom plan view of the tie table 10 in the halfway rotated position shown in FIG. 24 during a fourth operation of a tie cycle process showing the upper rotating table frame 130 rotated approximately 45 degrees from fore and aft and rotatably joined to the intermediate tilting table frame and the intermediate tilting table frame pivotally joined to the lower pivot frame 20 and showing a rotate left and rotate right sensor target 330 (actuator 58 and booster strut assembly not shown);

FIG. 26 is a side plan view of the tie table 10 in a partially raised position, a fully tilted up position, and in a post fourth operation position after completion of a fourth operation of a tie cycle process showing the upper rotating table frame 130 fully tilted up from the home tilt position and rotatably joined to the intermediate tilting table frame 70 and the intermediate tilting table frame pivotally joined to the lower pivot frame 20 and the tie table attached to the stack wagon 8 and showing the upper rotating table frame rotated generally 90 degrees to the longitudinal axis of the stack wagon and of the rear-hinged stack load table 14 and showing the bale layer of phantom Bale 3 (in front of behind Bale 4) and Bale 4 (actuator 58 and booster strut assembly not shown);

FIG. 27 is a side plan view of the tie table 10 in a transition position during a fifth operation of a tie cycle process showing the upper rotating table frame 130 partially tilted down from the post fourth operation position and rotatably joined to the intermediate tilting table frame and the intermediate tilting table frame 70 pivotally joined to the lower pivot frame 20 (actuator 58 and booster strut assembly not shown);

FIG. 28 is a side plan view of the tie table 10 attached to the stack wagon 8 in a post fifth operation of a tie cycle process showing the tie table raised generally 90 degrees and showing the upper rotating table frame 130 fully tilted down from the post fourth operation position and rotatably joined to the intermediate tilting table frame 70 and the intermediate tilting table frame pivotally joined to the lower pivot frame 20 and showing the upper rotating table frame rotated generally 90 degrees to the longitudinal axis of the vehicle and of the rear-hinged load table 14 and showing the bale layer of phantom Bale 3 in front of Bale 4 after their deposit on the stack load table;

FIG. 29 is a bottom plan view of the tie table 10 in a post fifth operation of a tie cycle process showing the upper rotating table frame 130 tilted down from the post fourth operation position and rotatably joined to the intermediate tilting table frame 70 and the intermediate tilting table frame pivotally joined to the lower pivot frame 20 (actuator 58 and booster strut assembly not shown);

FIG. 30 is a side plan view of the tie table 10 pivotally attached to the bale stack wagon 8 in a post sixth operation and partially through a seventh operation of a tie cycle process showing the tie table partially raised approximately 80 degrees and showing the upper rotating table frame 130 fully tilted up from the post fifth operation position and rotatably joined to the intermediate tilting table frame 70 and the intermediate tilting table frame pivotally joined to the lower pivot frame 20 showing the upper rotating table frame 130 rotated 90 degrees to the longitudinal axis of the stack wagon and of the stack load table 14 and showing the bale layer of phantom Bale 3 (in front of Bale 4) after their deposit upon and a lateral shift of their position along the stack load table by the upper rotating table frame (actuator 50 and booster strut assembly not shown);

FIG. 31 is a side plan view of the tie table 10 in a post seventh operation of a tie cycle process showing the tie table raised approximately 30 degrees and showing the upper rotating table frame 130 fully tilted up from the post sixth operation position and rotatably joined to the intermediate tilting table frame 70 and the intermediate tilting table frame pivotally joined to the lower pivot frame 20 (actuator 58 and booster strut assembly not shown);

FIG. 32 is a side plan view of the tie table 10 in a halfway rotated position during an eighth operation of a tie cycle process showing the tie table raised approximately 20 degrees and showing the upper rotating table frame 130 rotated approximately 45 degrees from fore and aft and fully tilted up from the post sixth operation position and rotatably joined to the intermediate tilting table frame 70 and the intermediate tilting table frame pivotally joined to the lower pivot frame 20 (actuator 58 and booster strut assembly not shown);

FIG. 33 is a side plan view of the tie table 10 in a post eighth operation of a tie cycle process showing the tie table raised approximately 20 degrees and showing the upper rotating table frame 130 fully rotated counter-clockwise (fore and aft) and fully tilted up from the post sixth operation position and rotatably joined to the intermediate tilting table frame 70 and the intermediate tilting table frame pivotally joined to the lower pivot frame 20 (actuator 58 and booster strut assembly not shown);

FIG. 34 is a side plan view of the tie table 10 in a post eighth operation of a tie cycle process showing the tie table raised approximately 20 degrees and showing the upper rotating table frame 130 fully rotated counter-clockwise (fore and aft) and fully tilted down from the post sixth operation position and rotatably joined to the intermediate tilting table frame 70 and the intermediate tilting table frame pivotally joined to the lower pivot frame 20 (actuator 58 and booster strut assembly not shown); and

FIG. 35 is a side plan view of the tie table 10 in the lowered home position after the tie cycle process is complete.

### DETAILED DESCRIPTION OF THE INVENTION

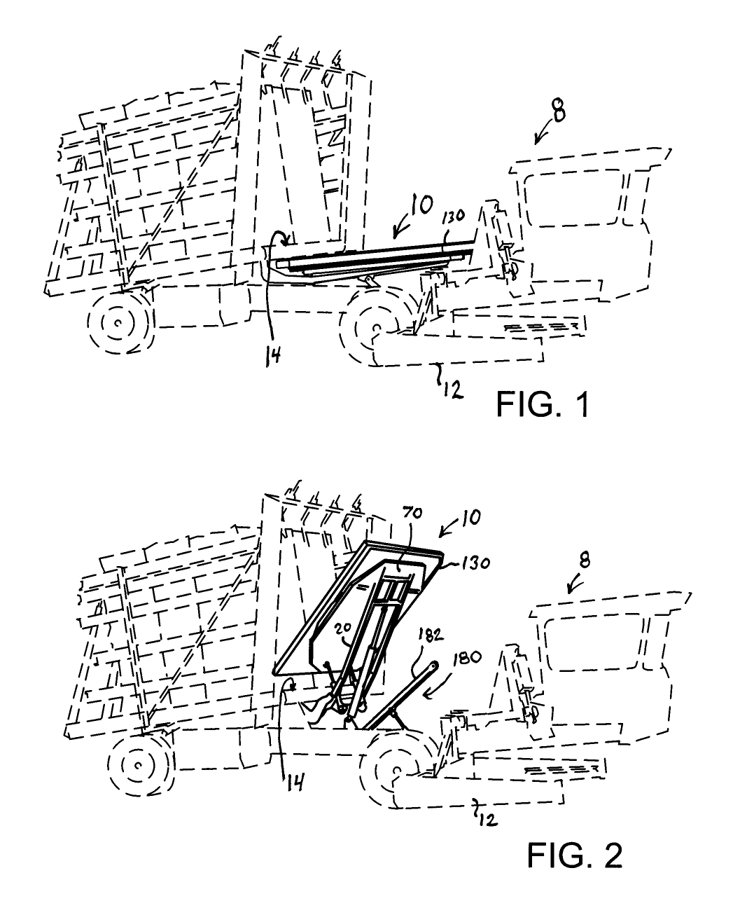

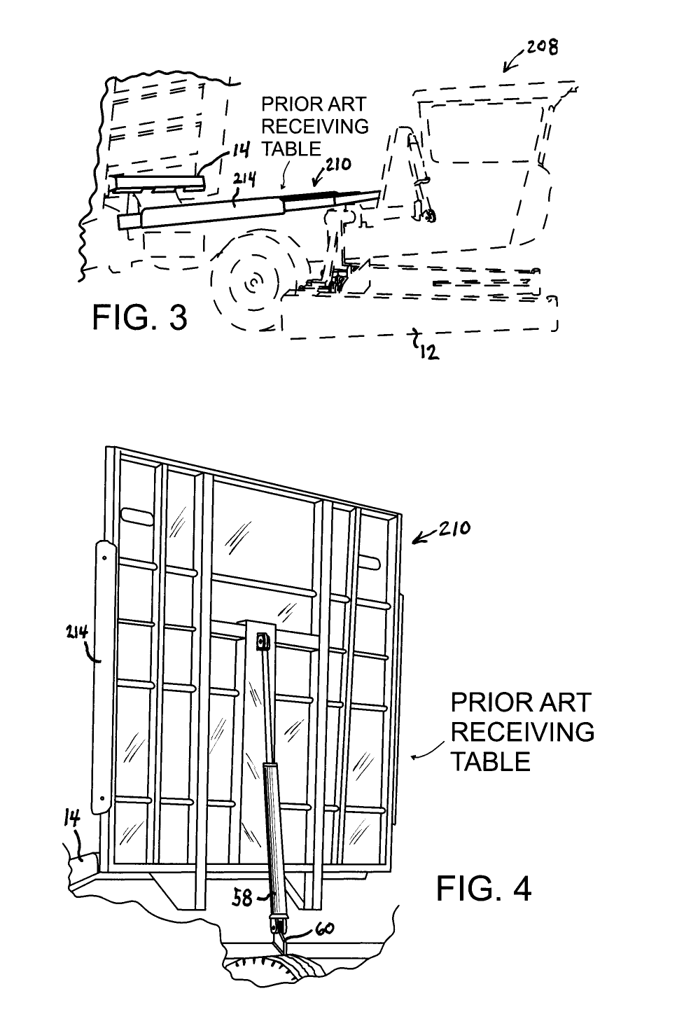

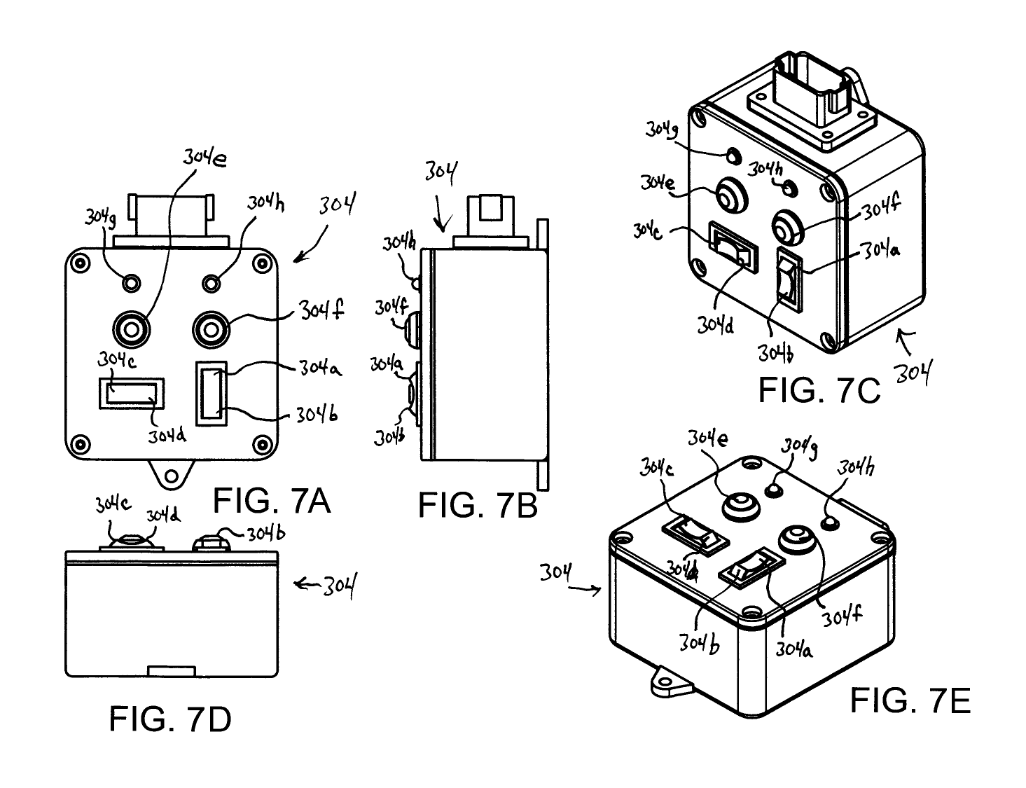

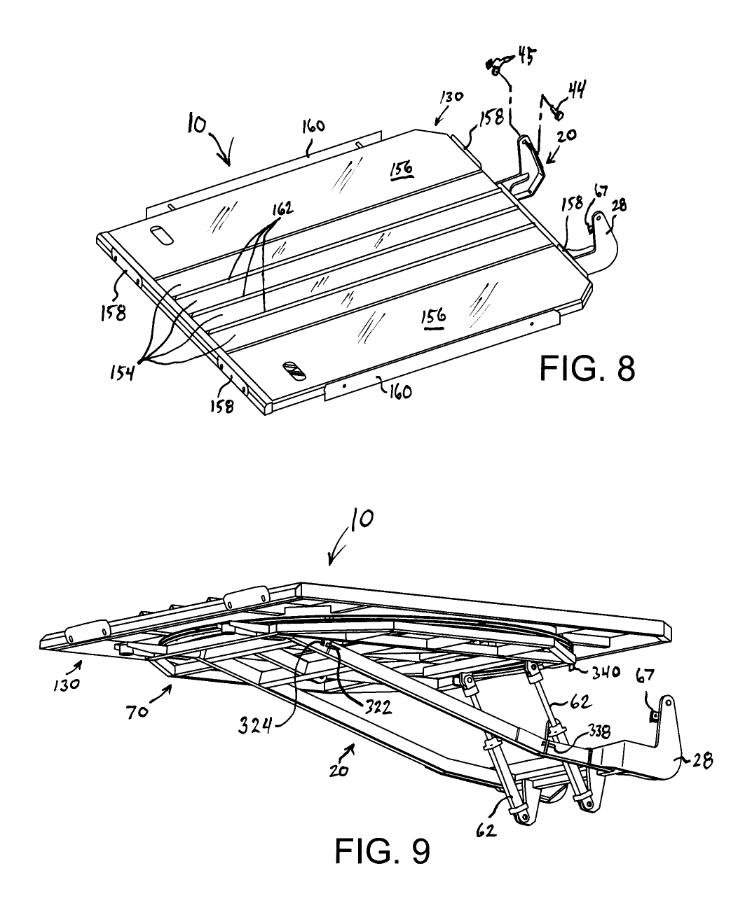

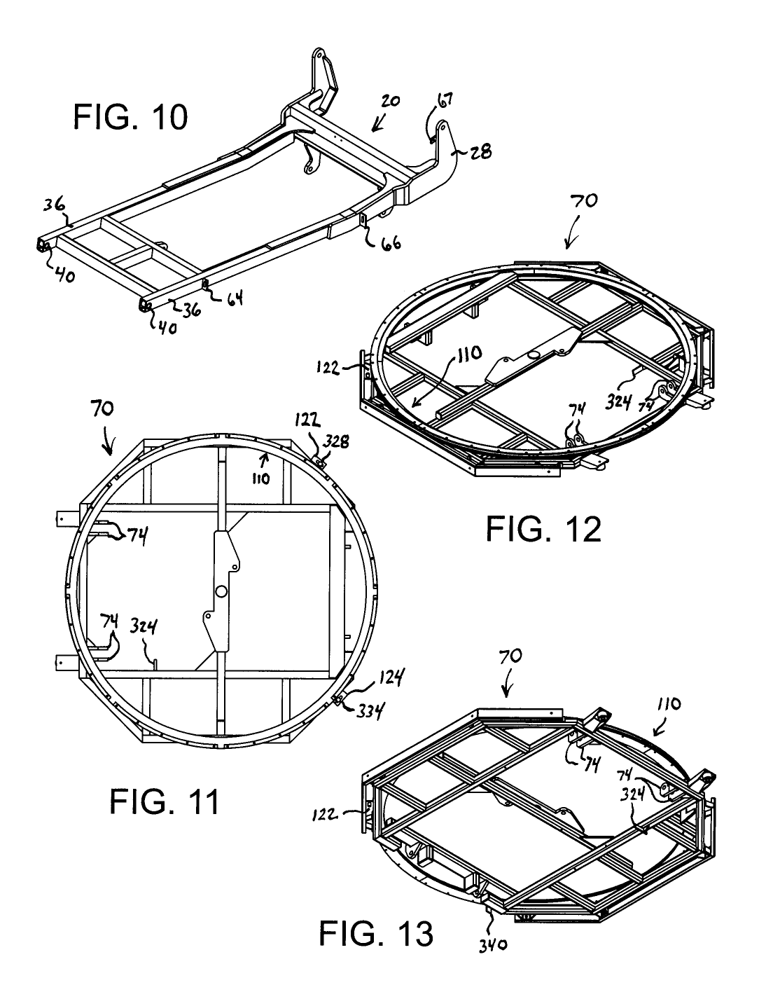

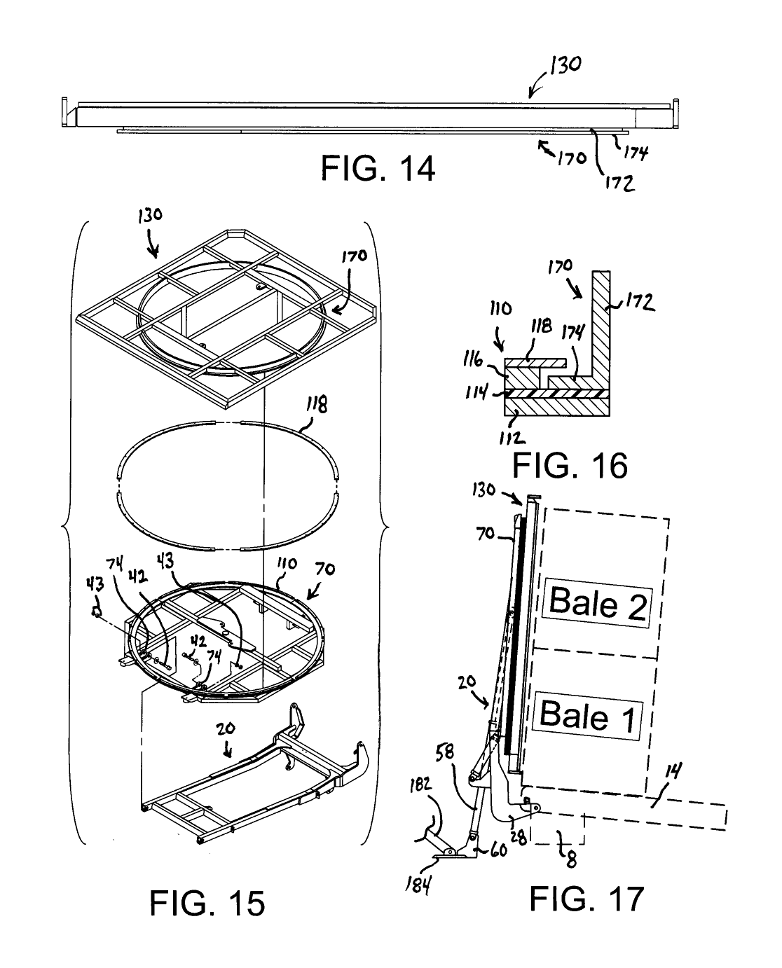

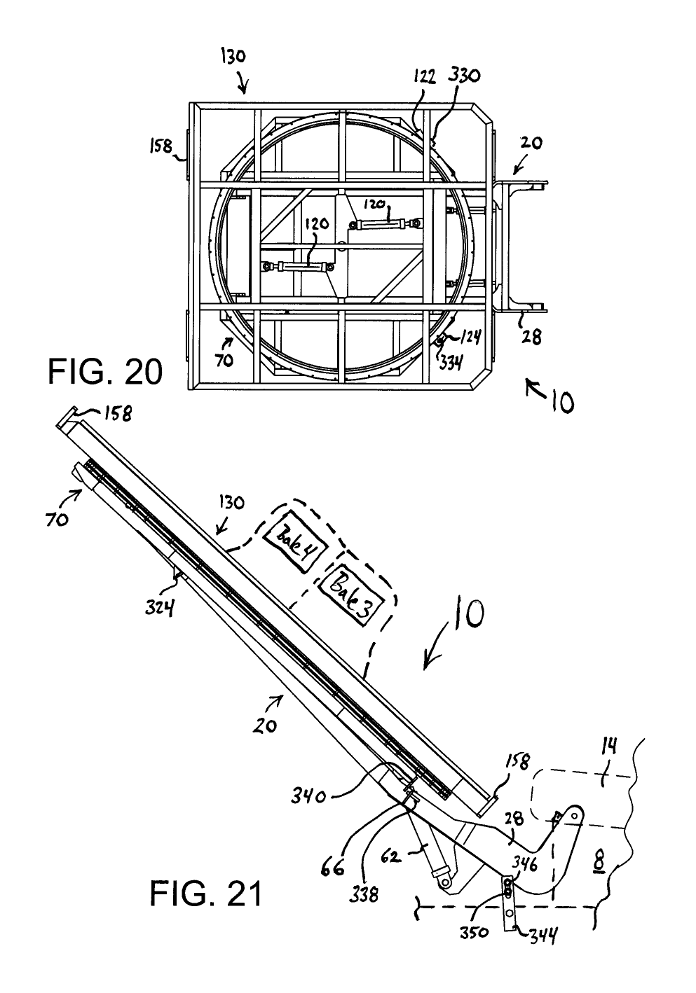

Referring to FIGS. 1 to 35, the tie table control system is a novel control system for a rearward-hinged and forward-hinged rotatable and tiltable tie table 10 for a bale wagon 8 having a rear-hinged stack load table 14 or other comparable bale transport vehicle.

A method of using the rotatable and tiltable tie table includes the tie table control system to monitor and to control movement of the tie table for selective lifting, selective tilting, selective rotating, and selective depositing of a bale layer from the tie table onto a rear-hinged stack load table the bale wagon.

The semi-automatic tie table control system 300 in its preferred embodiment is attached to a bale wagon to monitor and control a tie table 10 that has replaced a previously mounted non-rotatable, non-tiltable bale receiving table.

Referring to FIG. 15, a rotatable and tiltable tie table 10 (preferably is mounted on a bale wagon 8 previously equipped or concurrently being equipped with a Mil-Stak® bale loader 12 and having a rear-hinged stack load table 14), the tie table comprises:
A. a lower pivot frame 20 having two main pivot bolts 44 and jam nuts 45, two main cross rail pivot plates 28 (two rearward portions of said lower pivot frame), two spaced frame upper rails 36 (two forward portions of said lower pivot frame), two table pivot sleeves 40 coaxial to one another and each sleeve respectively located proximate to the distal ends of said upper rails away from said pivot plates, two pivot bolts 42 with jam nuts 43 for insertion into and retention within said pivot sleeves to pivotally join said lower pivot frame to an intermediate tilting table frame and one of the pivot plates has a bale wagon sensor mechanism tab 67 mounted thereon that replaces a similarly sized and positioned linkage tab member that mechanically linked the replaced table with a bale wagon control system of the bale wagon;
B. a table lifting actuator 58 rotatably connected between and to a table lifting actuator lower mounting ear 60 (an element of original bale wagon structure that was used to raise and lower the replaced bale receiving table and now is used to raise and lower the replacing tie table) and said lower pivot frame;
C. two tilting actuators 62 each tilting actuator rotatably and respectively connected between and to said lower pivot frame and an intermediate tilting table frame;
D. the intermediate tilting table frame 70 having two pairs of spaced intermediate tilting table frame pivot plates 74 (forward portions of the intermediate tilting table frame that are pivotally connected to said table pivot sleeves 40 of said lower pivot frame, see FIG. 15), a circular (annular) fixed planar ring assembly 110 generally centered and joined to the upperside of the rest of said intermediate tilting table frame and said fixed planar ring assembly having four rings each ring attached coaxially to the next ring preferably by a plurality of nuts and bolts said four rings being a base ring 112 attached to and beneath an ultrahigh molecular weight (UHMW) plastic ring 114 attached to and beneath a segmented spacer ring 116 attached to and beneath a segmented capture ring 118;
E. two rotation actuators 120 each rotatably and respectively connected between said intermediate tilting table frame and an upper rotating table frame 130;
F. said upper rotating table frame 130 having a generally planar upper inner table skin 154 and adjacent generally coplanar upper outer table skins 156, said skins joined to adjacent underlying portions of said upper rotating table frame, and a circular (annular) rotating ring assembly 170 generally centered and joined to the underside of the rest of said upper rotating table frame, said rotating ring assembly having an attachment ring 172 coaxially joined to a slider ring 174; and said upper rotating table frame rotatably joined by said capture ring to said intermediate tilting table frame, see FIGS. 15 and 16; and said tie table having optionally
G. a booster strut assembly 180 having a booster strut 182 rotatably attached to said bale wagon generally along the longitudinal centerline of said bale wagon by, a booster strut mount 184, said booster strut having a distal rotatable booster strut wheel located at the distal end of said booster strut, an upper booster strut actuator mounting ear located on a lower surface of said strut between said strut mount and said strut wheel, a lower booster strut actuator mounting ear attached to said bale wagon, and a booster strut actuator attached between said strut actuator mounting ears.

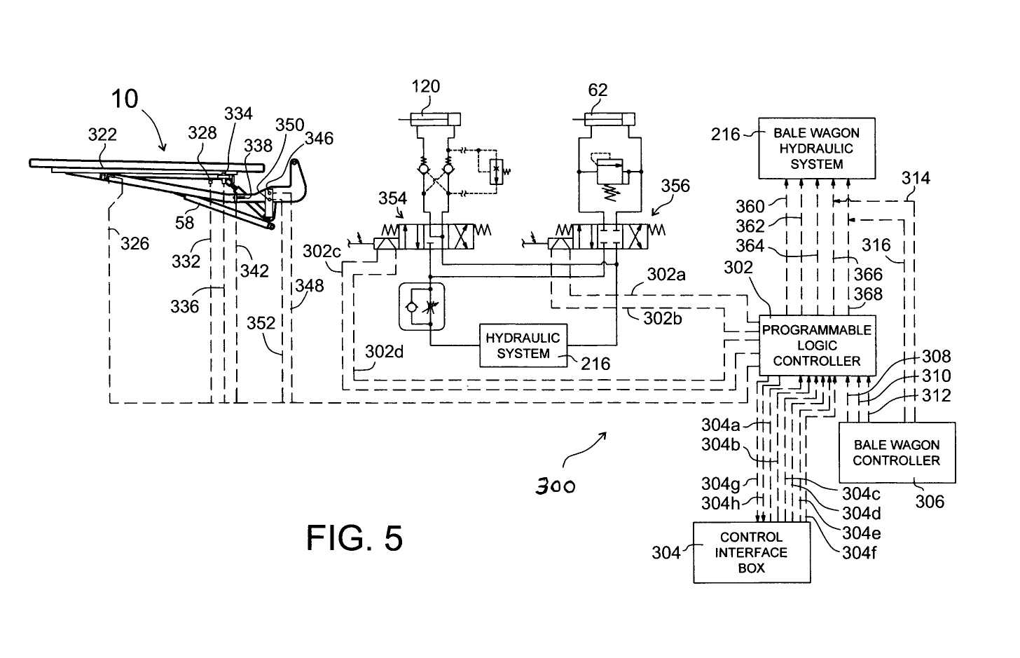

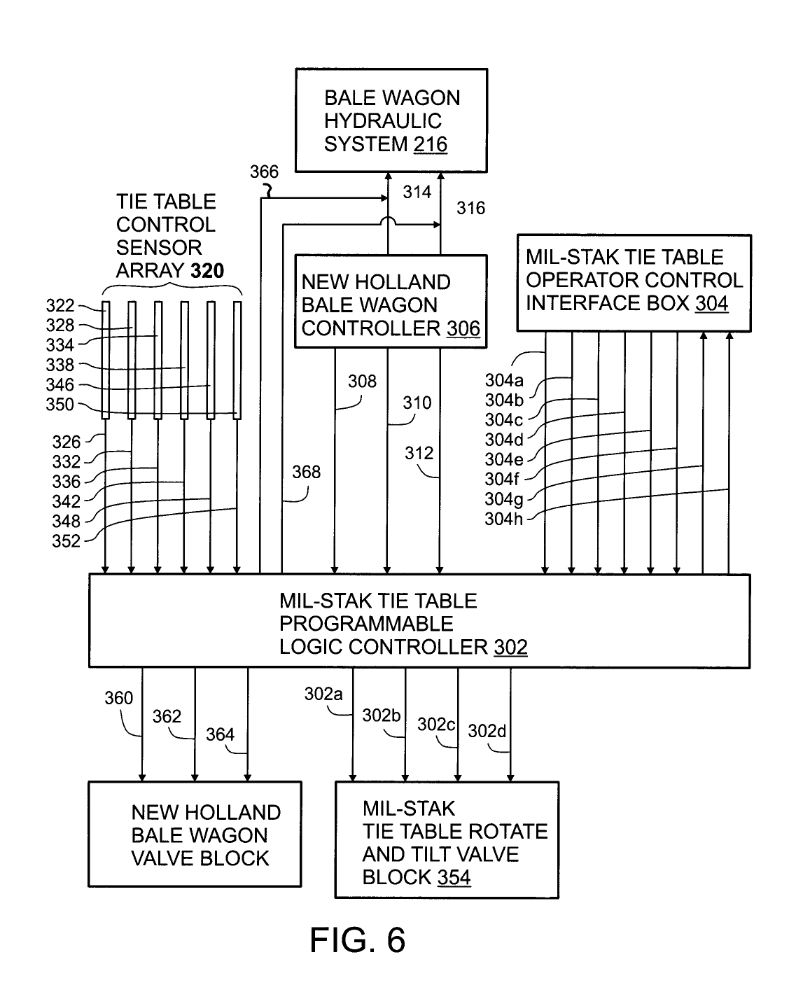

The semi-automatic tie table control system 300 attached to a bale wagon equipped with a rotatable and tiltable tie table comprises: a tie table programmable logic controller 302 attached to the bale wagon and electrically interconnected (see FIGS. 5 and 6) with an operator control interface box 304 attached to the bale wagon, with a bale wagon controller 306 attached to the bale wagon, with a tie table control sensor array 320 (six electrical inductive proximity sensors and associated sensor targets) attached to the tie table and to the bale wagon, with a tie table tilt and rotate valve block 354 attached to the bale wagon, and with a bale wagon hydraulic system 216.

The tie table programmable logic controller 302 (see FIGS. 5 and 6) selectively provides: a tie cycle tilt up signal 302a, a tie cycle tilt down signal 302b, a tie cycle rotate left signal 302c, a tie cycle rotate right signal 302d, a second table up signal 360, a second table down fast signal 362, a stack load table (load rack) up signal 364, a hydraulic load sense signal 366, and/or a second table down slow signal 368.

The operator control interface box 304 preferably has six manually activated switches and two status indicator lights: a switch that may initiate an operator manual tilt up signal 304a, a switch that may initiate an operator manual tilt down signal 304b, a switch that may initiate an operator manual rotate left signal 304c, a switch that may initiate an operator manual rotate right signal 304d, a switch that may initiate an automatic mode control signal 304e, and a switch that may initiate a tie cycle control signal 304f and an automatic mode active light 304g, and a tie cycle active light 304h.

The bale wagon controller 306 attached to the bale wagon selectively provides: a bale wagon second table up signal 308, a bale wagon second table down fast signal 310, a bale wagon stack load table up signal 312, a bale wagon load sense signal 314, and/or a bale wagon second table down slow signal 316.

The tie table control sensor array 320 (six electrical inductive proximity sensors) attached to the bale wagon comprises:
a tie table tilt up sensor 322 attached to said lower pivot frame by a mounting bracket 64 to monitor the proximate presence or absence of a ferrous metal tilt up sensor target 324 attached to said intermediate tilting table frame and to provide a tilt up sensor signal 326 (a binary signal);
a rotate left sensor 328 attached to said intermediate tilting table frame by a mounting bracket 122 to monitor the proximate presence or absence of a ferrous metal rotate left and rotate right sensor target 330 attached to an underside portion of said upper rotating frame 130 for rotation in unison therewith and to provide a rotate left sensor signal 332 (a binary signal);
a rotate right sensor 334 attached to said intermediate tilting table frame by a mounting bracket 124 to monitor the proximate presence or absence of said rotate left and rotate right sensor target and to provide a rotate right sensor signal 336 (a binary signal);
a table tilt down sensor 338 attached to said lower pivot frame by a mounting bracket 66 to monitor the proximate presence or absence of a ferrous metal tilt down sensor target 340 attached to said intermediate tilting table frame to provide a tilt down sensor signal 342 (a binary signal);
a tie table table up sensor and tie table table down sensor mounting bracket 344 attached to the bale wagon in a proximate, spaced and facing relationship to a selected vertical side of said lower pivot frame (preferably a generally vertical faced portion of main cross rail pivot plate 28);
a tie table table up sensor 346 attached to an upper portion of said mounting bracket 344 to monitor the proximate presence or absence of the lower pivot frame (pivot plate) and to provide a tie table table up sensor signal 348 (a binary signal); and
a tie table table down sensor 350 attached to a lower portion of said mounting bracket 344 to monitor the proximate presence or absence of the lower pivot frame (pivot plate) and to provide a tie table table down sensor signal 352 (a binary signal).

A tie table tilt and rotate valve block 354 is attached to the bale wagon and powers two tilting actuators 62 and two rotation actuators 120 in response to signals from the logic controller.

The bale wagon hydraulic system 216 powers a lifting actuator 58 that raises and lowers the tie table under the control of the logic controller and supplies hydraulic power to the tilting actuators, the rotation actuators, and the booster strut actuator.

Preferably, when operating a bale wagon equipped with a tie table and a tie table control system to retrieve bales, a bale wagon operator chooses to operate the bale wagon with the tie table control system in an automatic mode chosen by activating an automatic mode switch on the interface box once or twice until an automatic mode active light of the interface box illuminates (the light indicates the automatic mode is active) as opposed to operating the bale wagon in a manual mode. The selection of the automatic mode by the operator enables a subsequent selection by the operator of a tie mode by activation of a manual switch on the interface box.

The Automatic Mode:

If a tie table programmable logic controller automatic mode control (input) signal 304e transitions from an inactive state to an active state and the tie table programmable logic controller 302 is not in the automatic mode, the tie table programmable logic controller will switch to the automatic mode.

If the tie table programmable logic controller automatic mode control (input) signal 304e transitions from an inactive state to an active state and the tie table programmable logic controller 302 is in the automatic mode, the tie table programmable logic controller will switch to the manual mode.

The Tie Mode:

If the tie table programmable logic controller 302 is in the automatic mode and the tie table programmable logic controller tie cycle control (input) signal 304f transitions from an inactive state to an active state, the tie table programmable logic controller will switch to the tie cycle mode.

If the tie table programmable logic controller 302 is in the automatic mode and the tie table programmable logic controller is in the tie cycle mode, and the tie table programmable logic controller tie cycle control (input) signal 304f transitions from an inactive state to an active state, the tie table programmable logic controller will deactivate the tie cycle mode.

If the tie table programmable logic controller 302 is in the tie cycle mode and the tie table programmable logic controller switches from the automatic mode to manual mode, the tie table programmable logic controller will deactivate the tie cycle mode.

The Tie Cycle Process:

A tie table is controlled by a tie table control system to perform a tie cycle process.

Preferably, a tie cycle process is performed semi-automatically as follows: provide a bale wagon equipped with a tie table monitored and controlled by a tie table control system; preliminary to initiating a tie cycle process, a bale stack wagon operator places a tie table programmable logic controller 302 in an automatic mode by pressing an “Auto” button on an operator control interface box 304 and an automatic mode active light 304g illuminates;

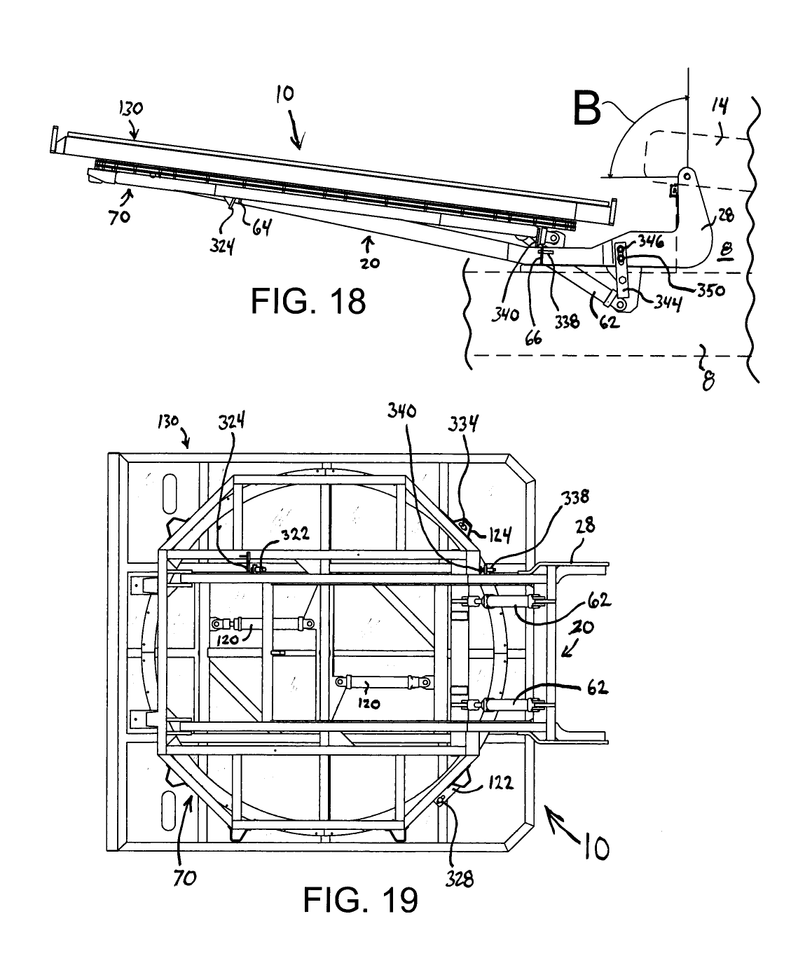

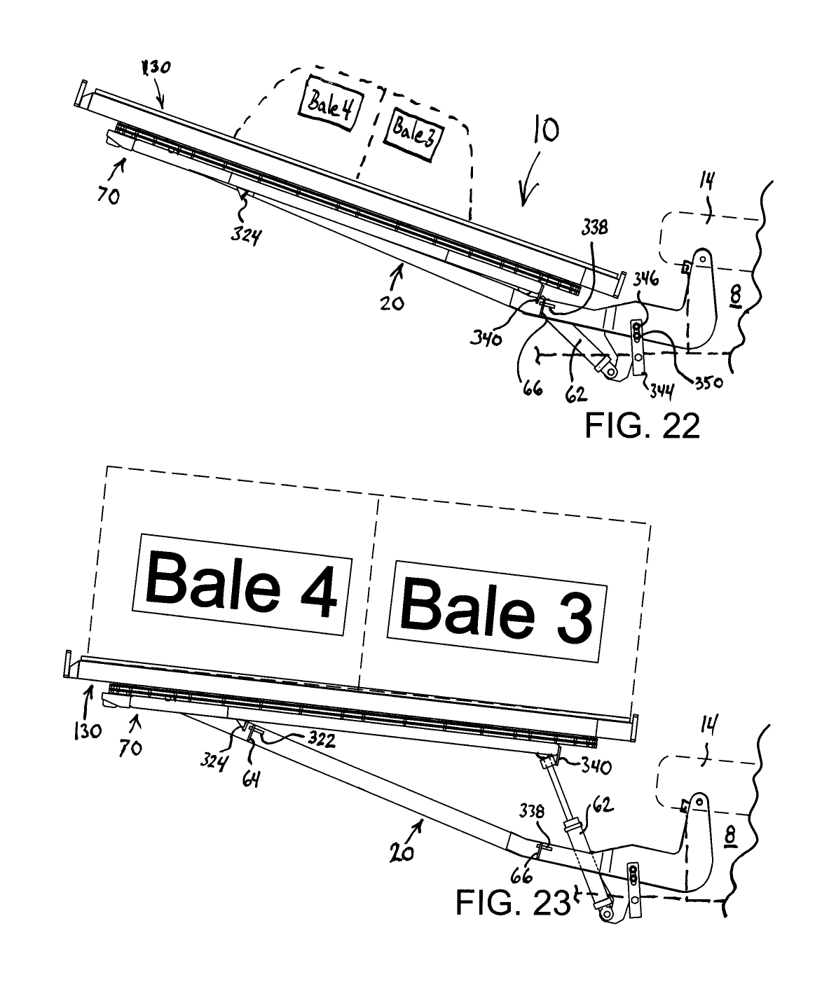

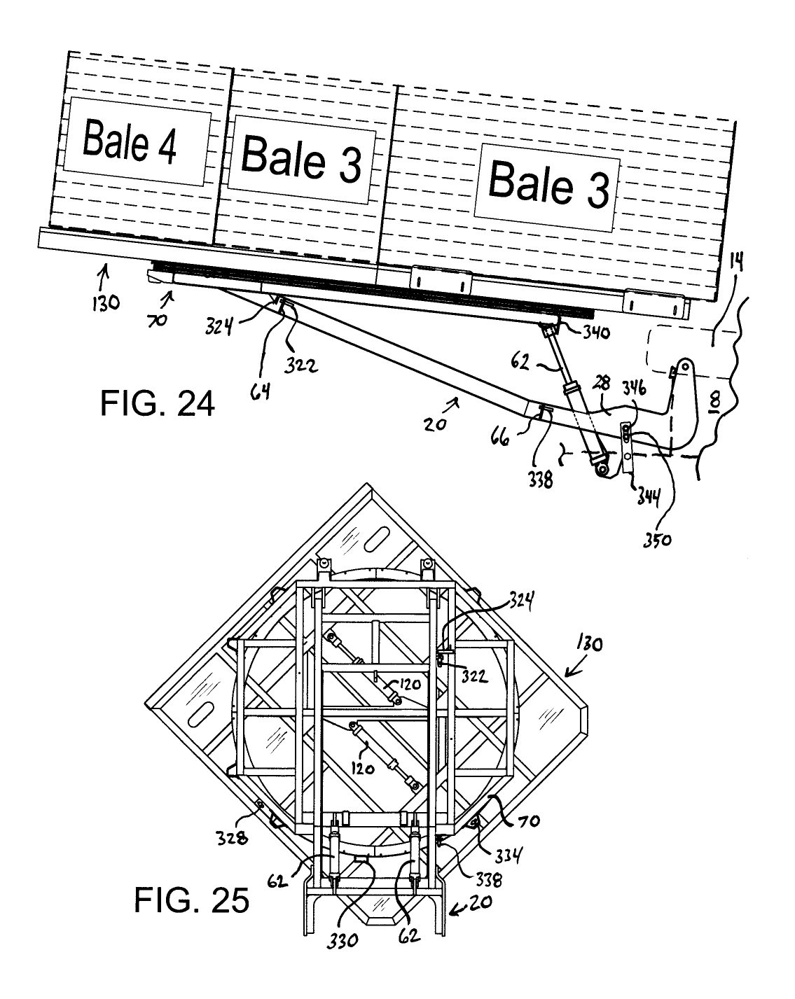

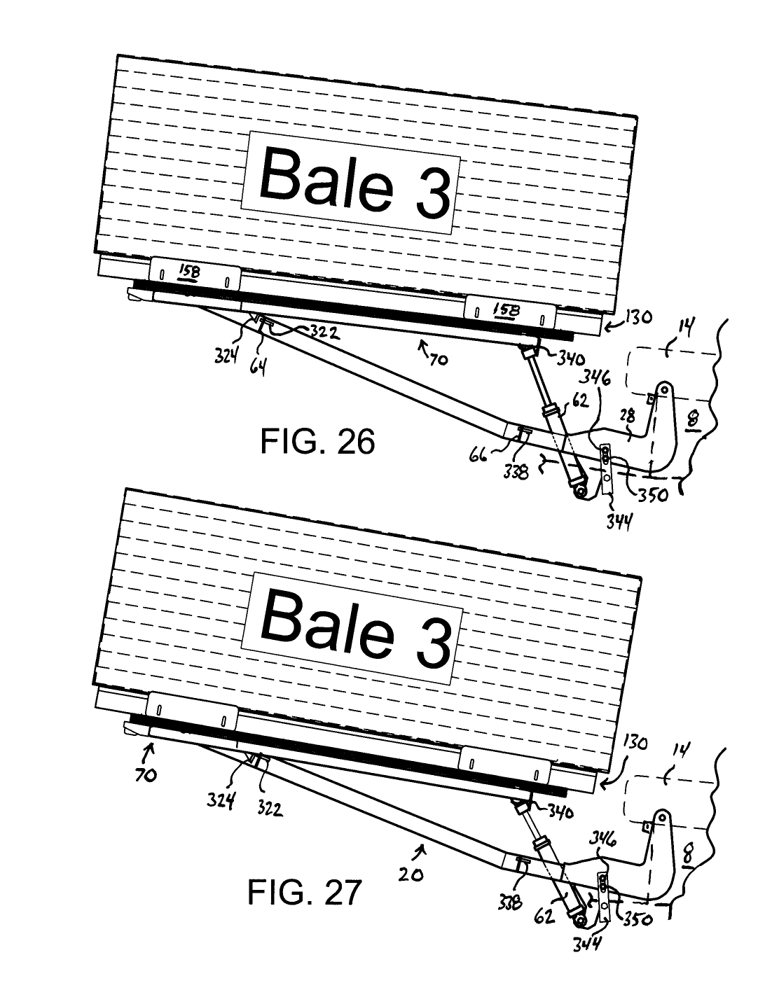

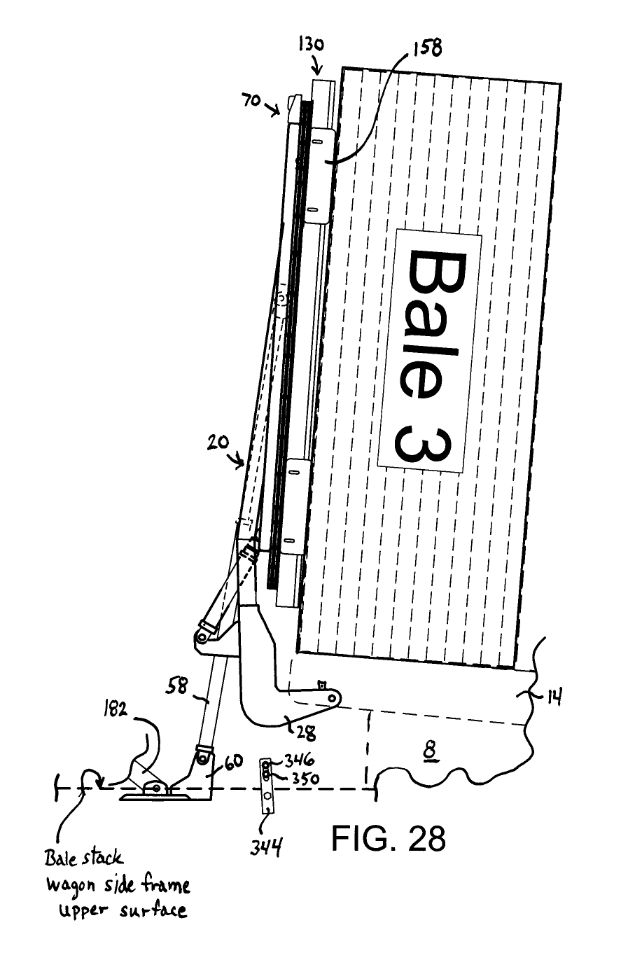

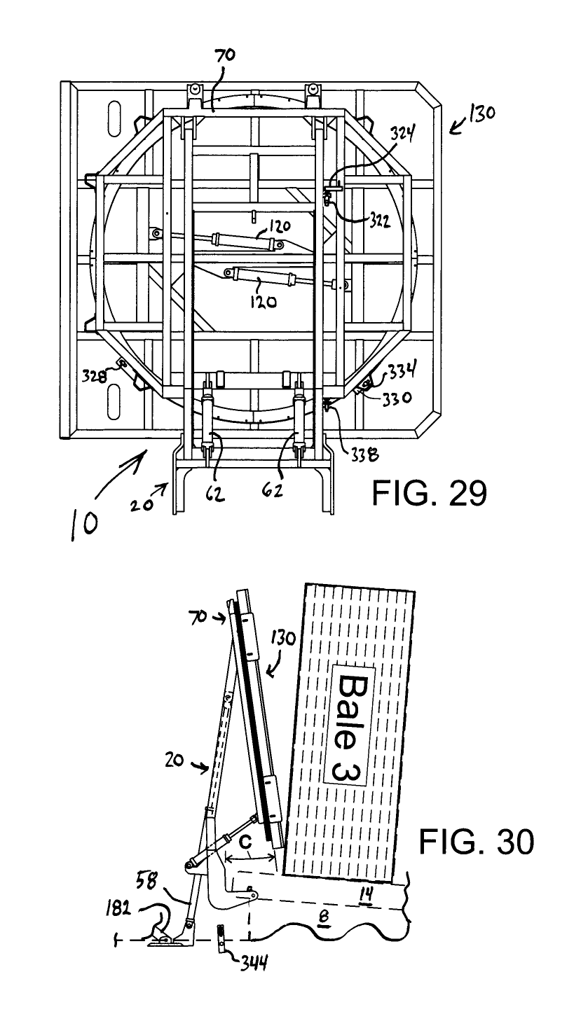

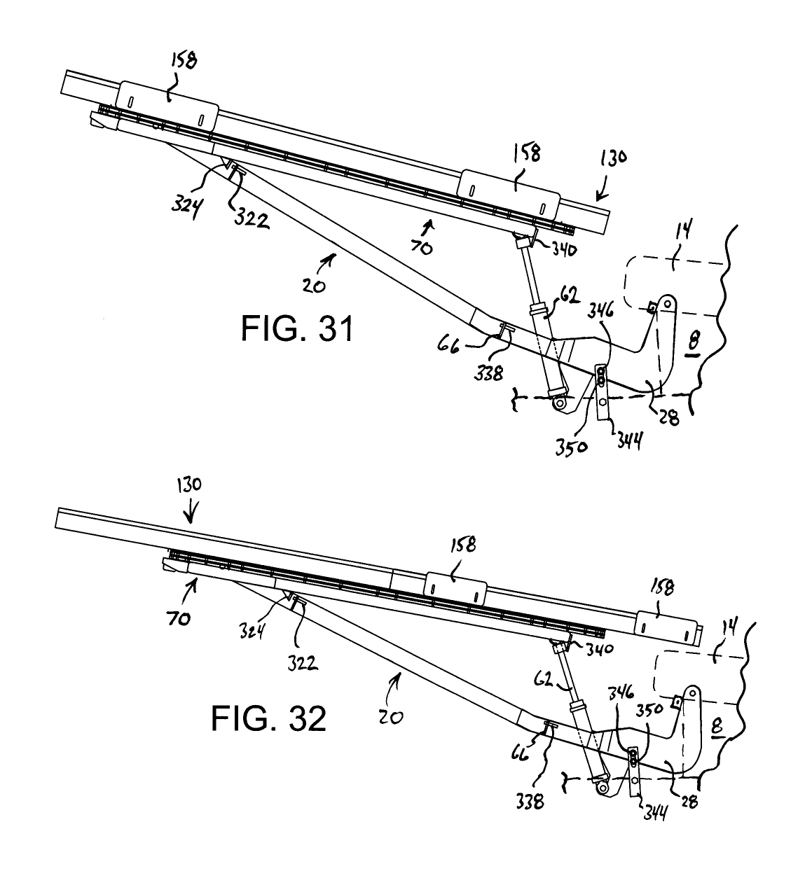

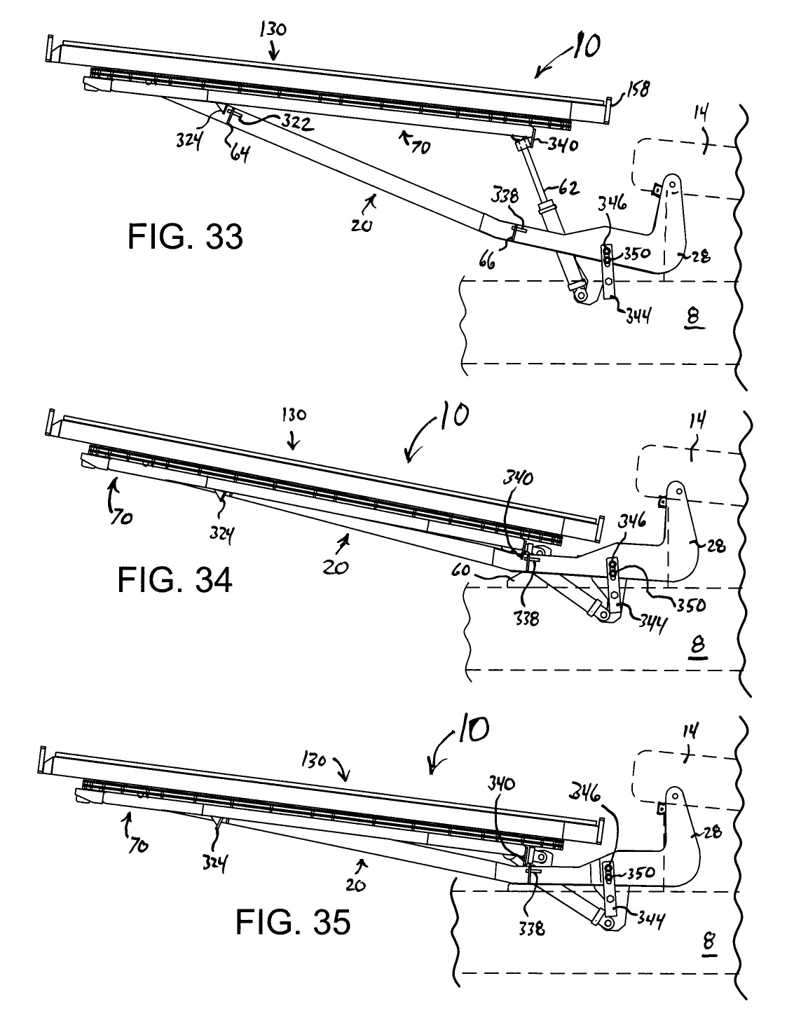

the operator loads a first bale of a tier of bales (a two bale layer of bales on a rotatable and tiltable tie table 10) with the tie table in a home position, see FIG. 18;
the tie table programmable logic controller 302 receives a bale wagon second table up signal 308 and a bale wagon second table down signal 310 and passes these signals directly to a hydraulic system 216 of the bale wagon activating a lifting actuator 58 to raise the tie table to a slide bale position and lower the tie table to a home position to slide the first bale to a rearward portion of the tie table to open a place at the front of table to receive a second bale;
the operator begins to load the second bale and while the second bale is being loaded, the operator presses a “Tie” button on the interface box to initiate a tie cycle process comprising ten operations (FIGS. 18 and 19 show the home position of the tie table at the beginning of a tie cycle process);
First Operation (raising the tie table to a slide bale position) if the logic controller is in the automatic mode, if the logic controller is in the tie cycle mode, if the bale wagon second table up signal 308 is received, if the tie table table down sensor signal 352 is active, if the tie table rotate left sensor signal 332 is active, and the tie table first operation has not been completed previously in the current tie cycle process; then the logic controller initiates a first operation of the tie cycle process (the tying sequence) by activating a second table up signal 360 and a tilt down signal 302b simultaneously with both signals remaining active until the first operation is complete;
if the second table up signal 360 is active, if the tilt down signal 302b is active, if the bale wagon second table up signal 308 is active, if the tie table table up sensor signal 348 is inactive, and if the first operation has not been completed previously in the current tie cycle process; then the logic controller 302 deactivates the second table up signal and the tilt down signal and the first operation is said to be complete (FIG. 21 shows the tie table 10 at the completion of the first operation);
as a safety measure, both signals of the first operation will be temporarily deactivated if the bale wagon controller deactivates the bale wagon second table up signal 308 (alternatively, the operator may cancel the tie cycle process by pressing the Auto button or the Tie button on the control interface box; once cancelled, all controller logic states in the logic controller are reset to a neutral and deactivated state);
Second Operation (lowering the tie table from the slide bale position to a position proximate and above the home position) if the first operation has completed during the current tie cycle process, if the logic controller is in the automatic mode, if the tie table table up sensor signal 348 is inactive, if the bale wagon second table up signal 308 is active, and if the tie table second operation has not been completed previously in the current tie cycle process; then the logic controller activates a second table down slow signal 368 and the logic controller is said to be in the second operation of the tie cycle process, the second table down slow signal 368 remains active until the second operation of the tie cycle process is complete;
if the first operation of the current tie cycle process is complete, if the tie table table down sensor 350 is active, and if the second operation of the tie cycle process has not been completed previously in the current tie cycle process; then the logic controller deactivates the second table down slow signal 368 and the second operation is said to be complete (see FIG. 22);
as a safety measure, the signal of the second operation will be temporarily deactivated if the bale wagon controller deactivates the bale wagon second table up signal 308 (alternatively, the operator may cancel the tie cycle process by pressing the Auto button or the Tie button on the control interface box; once cancelled, all controller logic states in the logic controller are reset to a neutral and deactivated state);
Third Operation (tilting up of the tie table) if the second operation has completed during the current tie cycle process, if the logic controller is in the automatic mode, if the bale wagon second table up signal 308 is active, if the tie table table down sensor signal 352 is active, and if the third operation has not been completed previously during the current tie cycle process; then the logic controller activates the tie table tilt up signal 302a and the tie table programmable logic controller is said to be in the third operation of the tie cycle process, the tie table tilt up signal 302a remains active until the third operation of the tie cycle process is complete;
if the second operation of the current tie cycle process is complete, if the tie table table down sensor signal 352 is active, if the tie table tilt up sensor signal 326 is active, and if the tie table third operation has not been completed previously during the current tie cycle process, the logic controller deactivates the tie table tilt up signal 302a and the third operation is said to be complete (see FIG. 23);
as a safety measure, the signal of the third operation will be temporarily deactivated if the bale wagon controller deactivates the bale wagon second table up signal 308 (alternatively, the operator may cancel the tie cycle process by pressing the Auto button or the Tie button on the control interface box; once cancelled, all controller logic states in the logic controller are reset to a neutral and deactivated state);
Fourth Operation (rotate upper rotating table frame 130 right (clockwise) generally 90 degrees) if the third operation has completed during the current tie cycle process, if the logic controller 302 is in the automatic mode, if the tie table table sensor down signal 352 is active, if the second operation of the current tie cycle process is complete, if the tie table tilt up sensor signal 326 is active, and if the fourth operation of the current tie cycle process has not been completed during the current tie cycle process; then the logic controller activates the tie table rotate right signal 302d and the logic controller is said to be in the fourth operation of the tie cycle process (FIGS. 24 and 25 show a transitory position of the upper rotating table frame 130 approximately halfway through the rotation of the fourth operation);
if the third operation of the current tie cycle process is complete, if the tie table rotate right sensor signal 336 is active, and if the fourth operation has not been completed previously during the current tie cycle process; the logic controller 302 deactivates the tie table rotate right signal 302d and the fourth operation is said to be complete (see FIG. 26);
as a safety measure, the signal of the fourth operation will be temporarily deactivated if the bale wagon controller deactivates the bale wagon second table up signal 308 (alternatively, the operator may cancel the tie cycle process by pressing the Auto button or the Tie button on the control interface box; once cancelled, all controller logic states in the logic controller are reset to a neutral and deactivated state);
Fifth Operation (transfer of bale layer from the tie table to a rear-hinged stack load table) if the fourth operation has completed during the current tie cycle process and if the fifth operation has not been previously completed during the current tie cycle process; then the logic controller activates the tie table tilt down signal 302b and then after a delay of approximately one second, see FIG. 27, the logic controller activates the second table up signal 360; the logic controller 302 is said to be in the fifth operation of the current tie cycle process; the tie table tilt down signal 302b and the second table up signal 360 remain in the active state until the fifth operation has completed;
if the fourth operation of the current tie cycle process is complete, if the bale wagon second table up signal 308 is deactivated, if the bale wagon second table down fast signal 310 is activated, and if the fifth operation has not been completed previously during the current tie cycle process; then the logic controller 302 deactivates the tilt down signal 302b and the second table up signal 360 and the fifth operation of the current tie cycle process is said to be complete (see FIGS. 28 and 29);
as a safety measure, the signal of the fifth operation will be temporarily deactivated if the bale wagon controller deactivates the bale wagon second table up signal 308 (alternatively, the operator may cancel the tie cycle process by pressing the Auto button or the Tie button on the control interface box; once cancelled, all controller logic states in the logic controller are reset to a neutral and deactivated state);
Sixth Operation (shove bales rearward on the stack load table) if the fifth operation has completed during the current tie cycle process and if the sixth operation has not been previously completed during the current tie cycle process; then the logic controller 302 activates the tie table tilt up signal 302a and the logic controller is said to be in the sixth operation; the tie table tilt up signal 302a remains active until the sixth operation has been completed;
if the fifth operation of the current tie cycle process is complete, if the tie table tilt up sensor 346 is active, and if the sixth operation of the current tie cycle process has not been completed previously during the current tie cycle process; then the tie table tilt up signal 302a is deactivated and the sixth operation of the current tie cycle process is said to be complete;
as a safety measure, the signal of the sixth operation will be temporarily deactivated if the bale wagon controller deactivates the bale wagon second table down signal 310 (alternatively, the operator may cancel the tie cycle process by pressing the Auto button or the Tie button on the control interface box; once cancelled, all controller logic states in the logic controller are reset to a neutral and deactivated state);
Seventh Operation (lower the tie table to an intermediate position towards the home position) if the fifth operation has completed during the current tie cycle process and if the seventh operation has not been previously completed during the current tie cycle process; then the logic controller 302 activates the second table down fast signal 362 after approximately a one second delay (see FIG. 30), the second table down fast signal 362 remains active throughout the duration of the seventh operation;
if the sixth operation of the current tie cycle process is complete, if the second table table up sensor signal 348 changes from the inactive state to the active state, and if the seventh operation has not previously completed during the current tie cycle process; then the logic controller 302 deactivates the second table down fast signal 362 after approximately a 100 millisecond delay and the seventh operation of the current tie cycle process is said to be complete (see FIG. 31);
as a safety measure, the signal of the seventh operation will be temporarily deactivated if the bale wagon controller deactivates the bale wagon second table down signal 310 (alternatively, the operator may cancel the tie cycle process by pressing the Auto button or the Tie button on the control interface box; once cancelled, all controller logic states in the logic controller are reset to a neutral and deactivated state);
Eighth Operation (rotate the upper rotating table frame 130 back to the home rotational position) if the seventh operation has completed during the current tie cycle process, if the eighth operation has not completed during the current tie cycle process, if the tie table tilt up sensor signal 326 is active, and if the tie table second table table sensor up signal 348 is active; then the logic controller 302 activates the rotate left signal 302c after approximately a delay of 750 milliseconds and the logic controller is said to be in the eighth operation of the current tie cycle process; the tie table rotate left signal 302c remains active throughout the duration of the eighth operation of the current tie cycle process;
if the logic controller 302 is said to be in the eighth operation, if the tie table rotate left signal 302c is active, and if the tie table rotate left sensor signal 332 is not active; then the logic controller will activate the bale wagon second table down slow signal 316 (see FIG. 32 shows the upper rotating table frame 130 approximately halfway through rotation towards the home rotational position during the eighth operation);
if the eighth operation of the current tie cycle process has not been completed during the current tie cycle process and if the tie table rotate left sensor signal 332 is in the active state, the logic controller 302 deactivates the rotate left signal 302c and the eighth operation is said to be complete (see FIG. 33);
as a safety measure, the signal of the eighth operation will be temporarily deactivated if the bale wagon controller deactivates the bale wagon second table down signal 310 (alternatively, the operator may cancel the tie cycle process by pressing the Auto button or the Tie button on the control interface box; once cancelled, all controller logic states in the logic controller are reset to a neutral and deactivated state);
Ninth Operation (tilting down for additional 1.5 seconds after tilt down sensor target 340 is observed by tilt down sensor 338) if the eighth operation of the current tie cycle process has completed, if the ninth operation of the current tie cycle process has not been completed during the current tie cycle process, and if the tie table tilt down sensor signal 342 is not active; then the logic controller 302 activates the tie table tilt down signal 302b and the logic controller is said to be in the ninth operation; the second table down signal remains active for the duration of the ninth operation of the current tie cycle process;
if the eighth operation of the current tie cycle process has been completed during the current tie cycle process, if the tie table tilt down sensor signal 342 is active, and if the ninth operation of the current tie cycle process has not been completed previously during the current tie cycle process; then the logic controller 302 deactivates the tie table tilt down signal 302b after a delay of approximately 1500 milliseconds and the ninth operation of the current tie cycle process is said to be complete (see FIG. 34);
as a safety measure, the signal of the ninth operation will be temporarily deactivated if the bale wagon controller deactivates the bale wagon second table down signal 310 (alternatively, the operator may cancel the tie cycle process by pressing the Auto button or the Tie button on the control interface box; once cancelled, all controller logic states in the logic controller are reset to a neutral and deactivated state);
Tenth Operation (places the tie table 10 in the home position) if the eighth operation of the current tie cycle process is complete and if the tenth operation of the current tie cycle process is not complete; then the tie table programmable logic controller 302 activates the bale wagon second table down slow signal 316 (via signal 368) and the logic controller is said to be in the tenth operation; the second table down slow signal 316 (via signal 368) remains active for the duration of the tenth operation of the current tie cycle process;
if the eighth operation of the current tie cycle process is complete, if the tenth operation of the current cycle has not previously been completed during the current tie cycle process, and if the bale wagon second table down signal 316 transitions from an active state to an inactive state; then the tie table programmable logic controller 302 deactivates the bale wagon second table down slow signal 316 (via signal 368) and the tenth operation of the current tie cycle process is said to be complete (see FIG. 35); and
when the tenth operation of the current tie cycle process is complete, the logic controller 302 sets all signals to an inactive state, resets all internal logic to an inactive state, and the current tie cycle process is said to be complete.

Steps carried out during a tie cycle process comprise:

1. a tie table programmable logic controller 302 is placed in an automatic mode by a bale wagon operator by pressing an Auto button on an operator interface box 304 before a bale loading process begins;

2. an operator initiates an automatic tie sequence by pressing a Tie button on the operator interface box while a second or a third bale is placed on a tie table 10 by a bale loader 12;

3. once the bale loader delivers the second or the third bale to the tie table and the logic controller receives a bale wagon second table up signal 308 from a bale wagon controller 306, the logic controller begins a tie cycle process;

4. the logic controller raises the tie table to approximately 45 degrees to a slide bale position to slide the bales on the tie table towards the rear portion of the tie table;

5. after reaching the slide bale position as determined by a tie table table up sensor 346 monitoring a main cross rail pivot plate 28 of the lower pivot frame 20 of the tie table as a sensor target, the logic controller lowers the tie table down to a rotate position determined by a tie table table down sensor 350 monitoring said main cross rail pivot plate 28;

6. once the tie table is in the rotate position, the logic controller tilts a rearward portion of the tie table up to a fully tilted up position as determined by a table tilt up sensor 322 mounted on the lower pivot frame monitoring a tilt up sensor target 324 mounted on an intermediate tilting table frame 70 of the tie table that generates a tilt up sensor signal 326;

7. after reaching the fully tilted up position, the logic controller rotates an upper rotating table frame 130 of the tie table clockwise generally 90 degrees (the specific degree of rotation is determined by a rotate right sensor 334 mounted on the intermediate tilting table frame 70 monitoring a rotation left and right sensor target 330 attached to an upper rotating table frame 130 that generates a rotate right sensor signal 336);

8. after rotating the upper rotating table frame generally 90 degrees, the logic controller tilts the tie table down for approximately one second before raising the tie table up to generally 90 degrees from the home position to transfer the bale layer from the tie table onto the stack load table;

9. once the tie table has transferred the bale layer to the stack load table, the bale wagon controller turns off a table up signal 308 and turns on a second signal (a table down fast signal 310)(the second signal is interpreted by the logic controller as a successful transfer of bales from the tie table to the stack load table);

10. once the table down fast signal is received by the logic controller, the logic controller tilts the rear portions of the tie table up for approximately one second to push rearward the bale layer onto the stack load table;

11. after approximately one second of tilting the rear portions of the tie table up, the logic controller begins to lower the tie table down towards the home position while continuing to tilt the rear portions of the tie table up;

12. as the tie table lowers towards the home position and the tie table table up sensor 346 transitions from an off state to an on state, the logic controller slows the descent of the tie table and rotates the upper rotating table frame counter-clockwise about its rotational axis to the home rotational position;

13. once the tie table is in its home rotational position, the logic controller tilts the rear portions of the tie table down to a home tilt position while continuing to lower the entire tie table to the tie table home position; and

14. once all the elements of the tie table are observed to be in their respective home positions, the tie table programmable logic controller resets itself to an idle state and waits for the next selected tie cycle process to begin.

Manual operation of each of the tie table movements is also allowed by the tie table control system by using the manual switches on the operator control interface box 304 that input into the logic controller.

The six actuators (the lifting actuator 58, two tilting actuators 62, two rotation actuators 120, and the booster strut actuator) controlled by the tie table control system and the tie table rotate and tilt valve block 354 are powered by a hydraulic system 216 of the bale wagon. In the figures, the hydraulic lines and the wiring harnesses are not shown except as depicted in FIGS. 5 and 6 to allow a clearer viewing of the structural elements of the invention.

A majority of the structural components of the tie table are preferably made from sheet steel stock, round or square steel tubing stock, or suitable materials used in making the preexisting receiving table. Means of joining of elements of the invention one to another preferably may include welding. The UHMW plastic ring is a high strength, durable plastic material that provides a slippery surface on which the slider ring may slide coaxially.

From the preceding, it should be apparent that the present invention a tie table control system has utility and provides a novel control system for a rotatable and tiltable tie table and methods that allow for convenient, easy modification of a bale transport vehicle to permit the lifting, tilting, rotating, and depositing of a bale layer from the tie table to a rear-hinged stack load table of a bale transport vehicle.

The preceding description and exposition of a preferred embodiment of the invention is presented for purposes of illustration and enabling disclosure. It is neither intended to be exhaustive nor to limit the invention to the precise form disclosed. Modifications or variations in the invention in light of the above teachings that are obvious to one of ordinary skill in the art are considered within the scope of the invention as determined by the appended claims when interpreted to the breath to which they are fairly, legitimately and equitably entitled.

We claim:

1. A tie table control system attached to an agricultural bale stack wagon to monitor and control the operative motions of a rotatable and tiltable tie table that receives and manipulates a layer of bales before depositing said layer of bales onto a rear-hinged stack load table of said bale transport vehicle comprising: a tie table programmable logic controller electrically interconnected to a tie table control sensor array by a plurality of input and output signal lines, said sensor array comprising a plurality of proximity sensors that interact with a plurality of respective cooperating sensor targets mounted to said tie table and said bale stack wagon to monitor tie table positions of tilting, rotating, and raising and to report via respective binary signal lines to said logic controller regarding the presence or absence of said targets in close proximity to said sensors; a tie table operator control interface box electrically interconnected to said logic controller by a plurality of input and output signal lines that allows operator selective input to said logic controller to set one or the other of two modes of tie table control as automatic mode or manual mode and to initiate or cancel a tie cycle process that controls said tie table to manipulate a selected bale layer according to programmed steps in the logic controller to rotate generally 90 degrees said selected bale layer relative to a layer loaded to said stack load table without a tie cycle being run; said logic controller electrically interconnected to a tie and rotate valve block by a plurality of control signal lines to control two tilting actuators and two rotation actuators; said logic controller electrically interconnected to a bale wagon controller to intercept and reroute a plurality of control signals, and said logic controller electrically interconnected to a bale wagon hydraulic system to control actuation of a lifting actuator and a booster strut actuator.

2. A tie table control system attached to an agricultural bale stack wagon to monitor and control the operative motions of a rotatable and tiltable tie table that receives and manipulates a layer of bales before depositing said layer of bales onto a rear-hinged stack load table of said bale transport vehicle comprising: a tie table programmable logic controller, a plurality of input and output signal lines attached between said logic controller, a bale stack wagon controller of said bale stack wagon, a hydraulic system of said bale stack wagon, a plurality of input and output signal lines attached between said logic controller and a plurality of hydraulic valves that control movement of a plurality of actuators associated with movement of the tie table during use, a plurality of input and output signal lines attached between the logic controller and a tie table rotate and tilt valve block, a plurality of input and output signal lines attached between said logic controller and a tie table control sensor array, said sensor array comprising a plurality of proximity sensors and a plurality of respective cooperating sensor targets mounted to said tie table and said stack wagon, a plurality of sensor targets 324, 330, 340 mounted to said tie table and a sensor target that is a sensor target portion of a lower pivot frame 20 (preferably said sensor target portion is a generally vertical surface of a pivot plate 28 of the lower pivot frame), a plurality of input and output signal lines attached between the logic controller and a tie table operator control interface box 304, and a plurality of input and output signal lines attached between the logic controller and a bale wagon valve block.
